(19) United States
(12) Patent Application Publication
(10) Pub. No.: US 2007/0150403 A1
(43) Pub. Date: Jun. 28, 2007

(54) Method and system for a mobile auction concierge

(75) Inventors: Von A. Mock, Boynton Beach, FL (US); Mark A. Barros, Wellington, FL (US); Daniel A. Baudino, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/320,193

(22) Filed: Dec. 28, 2005

(51) Int. Cl. G06Q 40/00

(52) U.S. Cl. 705/37

(57) ABSTRACT

A system (100) and method (600) is provided for auctioning an item using a mobile device (102). A mobile device can include a camera (202) for capturing an image of an item of interest, a processor (204) for entering the image into a database (140), an image recognition unit (206) for comparing the image to other images within the database, and a display (208) for presenting a list of comparable items available for auctioning. The mobile device can include a positioning system (210) for determining a location of the mobile device and identifying an entity having an item available for purchase or sale within a predetermined distance of the mobile device.

### FIELD OF THE INVENTION

The embodiments herein relate generally to methods and systems for wireless communications, and more particularly mobile networking.

### DESCRIPTION OF THE RELATED ART

For many mobile device users, Internet connectivity is an important aspect of life. Users can go on line to chat, check email, send messages, and exchange information. A user can be on line and always connected with a mobile device supporting Internet connectivity. One exciting aspect of being fully connected is having immediate access to news and information. Such information can include products for sale or purchase, and services being offered. Users can shop for products on-line, buying and selling, at their own convenience within the vicinity of their own home. Users can compare products on-line while looking at purchase factors such as price, quality, and service. Understandably, mobile devices have incorporated Internet application services for extending the purchasing power of the consumer.

In particular, EBay has redefined Internet commerce as a global interconnected market allowing users to actively engage in the mass exchange of market goods and services on-line. Using a computer or laptop, Internet users can list products for sale, buy products for sale, and comparison shop for goods on-line. With the large volume of goods traded on EBay, it can be a daunting task to keep track of which products are bought and sold, and under what categories those products fall. Internet users do not always know the name of the product they are looking to purchase, or necessarily the genre or class of the product. Finding a particular product can be a challenge for users not intimately familiar with the buying and selling process. Additionally, the majority of mobile devices do not provide an easy interface for entering large amounts of text for searching of items on the Internet. However, most mobile devices do incorporate a camera or other imaging capabilities that allows the user to easily capture items of interest. Therefore, what is needed is a way to leverage the simple image capture input through a mobile device to provide availability of items of interest on-line.

### SUMMARY

The embodiments of the invention concern a method and system for providing an auction concierge service using a mobile communication device. The auction concierge service facilitates search and monitoring of items posted for auction through the use of a camera equipped communication device. A user, having an interest in purchasing or selling a particular item, can take a picture of an item and upload an image of the item to a server hosting an image recognition service. The image recognition service can recognize the image and identify other objects available for sale or purchase on-line. The auction concierge service can interface with the image recognition service for communicating search results to a user. The auction concierge can include a broker service for conducting buy and sell activity on behalf of the user in a “live” auction environment. The auction concierge can identify a location of the mobile device and inform the user of entities within the area that have the item of interest available. The auction concierge service can activate a push-to-talk connection for placing a buyer and seller in immediate contact.

Embodiments of the invention also concern a method of auctioning an item using a mobile device. The method can include capturing an image of an item of interest, entering the image into a database, comparing the image to other images within the database for producing a list of comparable items, and presenting at least a portion of the list of comparable items at the mobile device for auctioning. The method can further include providing an auction concierge service for posting a sale or purchase of the item of interest. The method can further include adding descriptive content for association with the image and identifying at least one attribute within the image of the item of interest. The attribute can be a price, a quality, an age, a location or a model. For example, the item of intended purchase can be within a predetermined distance of a user. The auction concierge service can also provide relevant consumer reporting on uploaded images.

In another aspect, the method can include conducting a live auction wherein a broker acquires at least one image at auction and searches for buyers on-line. The auction concierge service can place a broker and a buyer in direct contact for bidding on an item of interest. For example, a user takes a picture of an item of interest on a mobile communication device, and a list of comparable items are presented to the user on the mobile communication device. The list of comparable items can include images of comparable objects for sale, prices, a quality, and a location of a place of entity for purchasing the objects. The auctioning service can identify at least one party to contact, and establishing communication between at least two parties for transacting a sale of an item. For example, the buyer and the seller can be placed in immediate contact for transacting a sale using a push-to-talk feature.

In yet another aspect, the method can include determining a location of the mobile device, and identifying a entity within a predetermined distance of the mobile device in view of the location. The entity can have access to at least one comparable item that is available for purchase or sale. The auction concierge service can provide an authentication process for ensuring secure transactions. The auction concierge service can provide a monetary brokerage for closing finances of the auction transaction.

The method further includes cataloging an image in a database, identifying a party having interest in the item as a buyer or a seller, and sending a message to the party for informing the party of comparable items within the database that are available for purchase or sale. For example, a server can host a database and match a buyer's image with one or more seller's images for bringing together the buyer and a seller.

Embodiments of the invention also concern a mobile device for providing auction concierge services. The system can include a camera for capturing an image of an item of interest, a processor connected to the camera for entering the image into at least one database, an image recognition unit communicatively coupled to the processor, and a display for presenting a list of comparable items available for sale or purchase. The image recognition unit can compare the image to other images within a database for providing the list of comparable items. The mobile device can further include a positioning system communicatively coupled to the processor. The positioning system can determine a location of the mobile device, and the processor can identify a entity within a predetermined distance of the mobile device based on the location. The mobile device can include a timer that can establish a time limit for honoring a purchase or sale of an item. In one arrangement, at least one database can be on a remote server.

Embodiments of the invention also concern a system for supporting auction concierge services. The system can include a processor for receiving and entering an image into at least one database, an image recognition unit communicatively coupled to the processor, and a publisher for publishing a list of comparable items available for auctioning.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a mobile communication environment in accordance with an embodiment of the inventive arrangements;

FIG. 2 depicts a mobile device for auctioning in accordance with an embodiment of the inventive arrangements;

FIG. 3 depicts an auction server in accordance with an embodiment of the inventive arrangements;

FIG. 4 presents a method for mobile auctioning in accordance with an embodiment of the inventive arrangements; and

FIGS. 5 and 6 present a flow chart of a method for mobile auctioning in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as any number of suitable components that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an item method, an item implementation, an executable application, an applet, a servlet, a source code, an item code, a shared library/dynamic load library and/or other sequence of instructions designed for execution on a computer system. The term “auction” is defined as any type of financial transaction.

Embodiments of the invention concern a system and method for auctioning an item in a mobile communication environment. The system can receive an image of the item of interest, enter the image into a database, compare the image to other images within the database, produce a list of comparable items, and present the list of comparable items for auctioning. Auctioning can include placing an item up for sale or purchasing an item. The mobile device provides auction concierge services that inform a user of one or more items for sale or purchase. The auction concierge service can include a broker to bid and accept offers on behalf of a buyer or seller that cannot timely participate in an auction. The auction concierge service can include the buying and selling of items available through conventional purchasing systems such as e-retailers or standard store order retailers. The auction concierge service applies to items available through normal purchasing and buying channels. In one arrangement, the mobile device can identify a entity having access to the item for sale, wherein the entity is located within a predetermined distance of the mobile device. In yet another arrangement, the auction concierge service provides an authentication process for ensuring secure transactions. The auction concierge service can also provide a monetary brokerage for closing finances of an auction transaction.

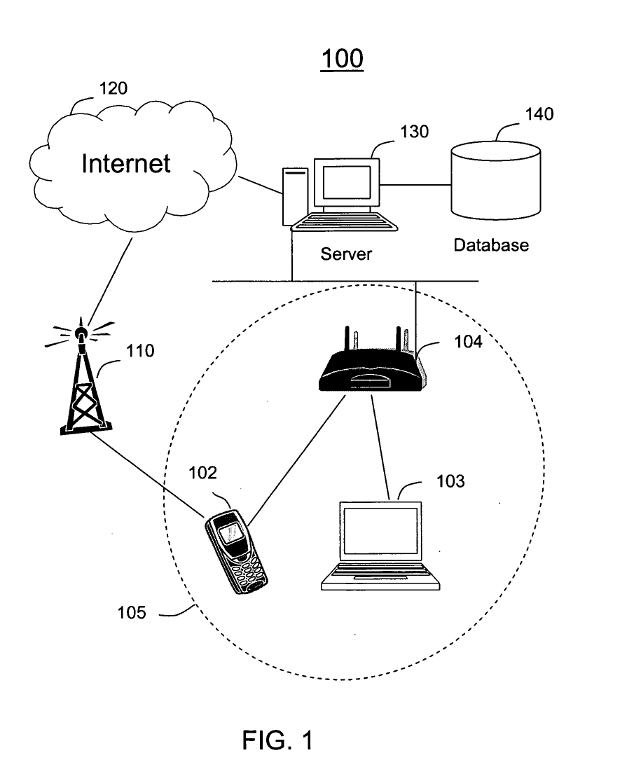

Referring to FIG. 1, a mobile communication environment 100 is shown. The mobile communication environment 100 can provide wireless connectivity over an radio frequency (RF) communication network or a Wireless Local Area Network (WLAN). In one arrangement, the mobile device 102 can communicate with a base receiver 110 using a standard communication protocol such as CDMA, GSM, or iDEN. The base receiver 110, in turn, can connect the mobile device 102 to the Internet over a packet switched link. The mobile device 102 can also connect to other communication devices through the Internet 120 using a wireless communication channel. The mobile device 102 can establish connections with a server 130 on the network and with other mobile devices for exchanging information. The server 130 can have access to a database 140 that is stored locally or remotely and which can contain image data. The server 130 can be an image server for entering and retrieving image data. The image server 130 can include image search engines for identifying images of interest.

The mobile device 102 can also connect to the Internet over a WLAN 104. Wireless Local Access Networks (WLANs) provide wireless access to the mobile communication environment 100 within a local geographical area 105. WLANs can also complement loading on a cellular system, so as to increase capacity. WLANs are typically composed of a cluster of Access Points (APs) 104 also known as base stations. The mobile communication device 102 can communicate with other WLAN stations such as a laptop 103 within the base station area 105. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 102 can send and receive data to the server 130 or other remote servers on the mobile communication environment 100. In one example, the mobile device 102 can send and receive images from the database 140 through the server 130.

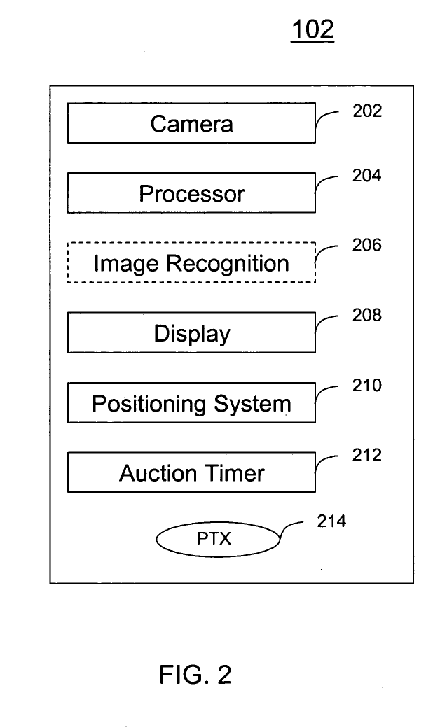

Referring to FIG. 2, a mobile device 102 for providing auction concierge services is shown. The mobile device 102 can include a camera 202 for capturing an image of an item of interest, a processor 204 connected to the camera for entering the image into at least one database, an image recognition unit 206 communicatively coupled to the processor 204, a display 208 for presenting a list of comparable items available for sale or purchase, and a push-to-talk (PTX) feature 214 for connecting a communication between a buyer and a seller. PTX technology provides quick easy connection to other devices through voice, media, imaging, text or other forms of communications. Push-to-talk is a subset of the capabilities provided by PTX. The image recognition unit 206 can compare the image to other images within a database and provide a list of comparables to the mobile device 102. Understandably, the image recognition unit 206 can also be on the server to offload processing. Comparable items are items that substantially match the visual features of the item in the requested image. The display 208 can visually inform or auditorily inform the user of the image search results. Upon identifying a comparable item of interest, a user can depress the PTX feature 214 to engage in a transaction.

Briefly, the mobile device 102 can be a cell phone, a personal digital assistant, a laptop, or the like. A user can identify an item of interest, and take a picture of the item, i.e. the user has an interest in buying or selling the item. The camera 202 can be used to take a picture of the item and the processor 204 converts the picture to a requested image. The processor 204 can store the requested image to a database in an uncompressed format such as PCM, or compressed format such as JPEG, TIF, or GIF. The database can be on the mobile device 102, or on a server on the network. The image recognition unit 206 can compare the requested image to other images within the database thereby identifying items of similar physical characteristics. The image recognition unit 206 may preferably reside on the server, and is shown for the purpose of enablement in the illustration of FIG. 2. The processor 204 can retrieve a list of comparable items that match the requested image. The processor 204 can present the list of comparable items on the display 208, which can include textual content and descriptive content.

In one arrangement, the processor 204 can host software applications for posting the item at auction, thereby providing auction concierge services. For example, the mobile device 102 can support Java 2 MicroEdition (J2ME) graphical user interface applications. The J2ME application can include options to enter in textual information for describing the item. For example, the J2ME application can accept descriptive content such as the price range of the item, the quality of the item, the age of the item, the history of the item, and a preferred location of the item. For example, the user may be willing to travel up to a certain distance or city limit to purchase the item. The J2ME application can include and associate the descriptive content with the item image. The J2ME application can also provide an image identification option for pointing out features which accurately identify and particularly point the important attributes of the item. For example, the J2ME application can support a zoom option or a stylus option to zoom in on certain features within the image. This may clearly distinguish the item from other items of similar form or from background clutter. The J2ME application allows the user to isolate the features considered important by the user in making their purchase decision. Notably, particularly pointing out and distinctly claiming the identifying features within the image improves the pattern recognition performance.

The mobile device 102 can further include a positioning system 210 to determine a location of the mobile device 102. Such positioning system can use satellite position system (SPS) satellite receivers, base station identifiers, access point identifiers, time of arrival techniques or other known location identifying methods. Understandably, the mobile device 102 can locate an entity having the item for sale or purchase. The processor 204 can identify an entity having the item within a predetermined distance of the mobile device 102. An entity can list contact information when placing an item for auction or when soliciting interest for an item. For example, the list of comparable items can include descriptive content that identifies physical attributes of the item such as size, weight, height and/or purchase attributes such as price, item location, quality, and age. The descriptive content can include buyer and seller reviews, consumer reporting information, item purchase history, reserve information, and support items. In one example, the attributes can be included in a meta data format with the list of comparables.

The mobile device 102 can further include an auction timer 212. The auction timer 212 can establish a time limit for honoring a purchase or sale of the item. The auction timer 212 can access a calendar or clock on the device, or it can receive timing information over the network. Briefly, a user using the mobile device can take a picture of an item, enter descriptive content, and post the item for auction. The auction timer can set a start time for bidding and an end date for final bids. The auction timer can countdown the time limit until the item is bought, sold, or removed. The timer 212 can log the number of attempts and responses made during a bid of an item at auction.

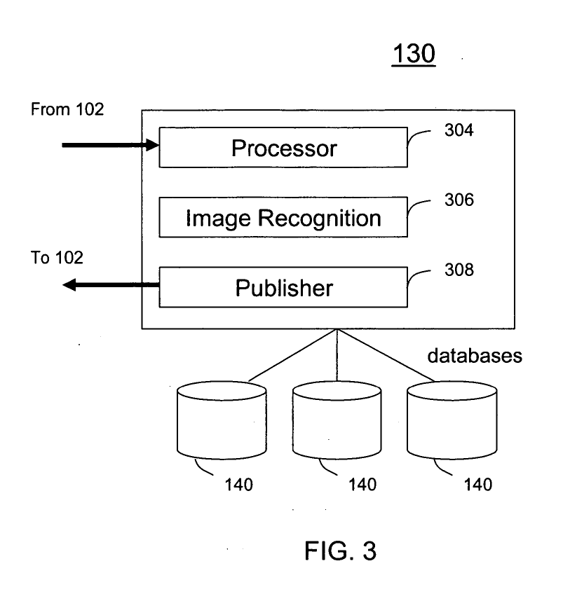

Referring to FIG. 3, a system 130 for supporting auction concierge services is shown. The system 130 can include a processor 304 for receiving and entering an image into at least one database 140, an image recognition unit 306 communicatively coupled to the processor 302, and a publisher 308 for publishing the list of comparable items available for sale or purchase. The publisher 308 can post the item of interest to other databases or servers supporting an auction concierge service. Briefly, the image recognition unit 306 compares the image to other images within a database 140 for creating a list of comparable items. The system 300 can communicate with a mobile device for providing image search services. The system 300 also provides relevant consumer reporting information on images uploaded to the server 130. The system 300 can receive an image captured by the mobile device, compare the image to other images in a database, and identify items in a database having similar features. The system 300 can send a message to the mobile device informing the device of found items for sale or purchase.

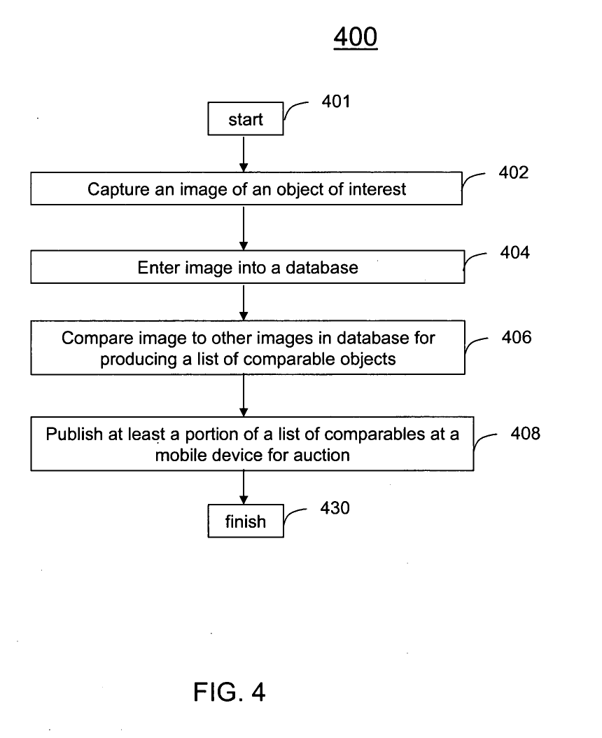

Referring to FIG. 4, a method 400 is shown for auctioning an item using a mobile device. When describing the method 400, reference will be made to FIGS. 1, 2 and 3, although it must be noted that the method 400 can be practiced in any other suitable system or device. Moreover, the steps of the method 400 are not limited to the particular order in which they are presented in FIG. 4. The inventive method can also have a greater number of steps or a fewer number of steps than those shown in FIG. 4.

At step 401, the method can start. At step 402, an image of an item of interest (e.g. item) can be captured. For example, a potential buyer visually identifies an item that the buyer is interested in purchasing. The buyer could be in a store shopping or outside wherein an item of interest captures the buyer's attention. The buyer may be curious to the cost of the item or to particular attributes of the item. For example, the item can be a bicycle, and the buyer is interested in learning about the price, quality, or mechanics of the bicycle. Referring to FIG. 2, the buyer takes a picture of the item with the camera 202 of the mobile device 102 to capture an image of the item. The mobile device 102 presents a display 208 which allows the buyer to enter in descriptive information that is associated with the item. For example, the buyer enters in a price range, a quality, an acceptable age, or a model to provide attributes the buyer considers relevant in the purchasing decision. The buyer enters descriptive content into the mobile device 102 to be associated with the item image.

At step 404, the image is registered with a database. For example, referring to FIGS. 1 and 2, the processor 204 communicates with the server 130 and registers the item into the database 140 hosted by the server 130. The server may only need a local copy and need not necessarily physically enter the image into the database. The term registering is defined as entering an item for search which can include keeping the item in a search registry or discarding the item after a search query. The processor 204 attaches the descriptive content entered by the user with the item for clarifying the search or inquiry request. Accordingly, the mobile device 102 sends image information and/or descriptive information to the server 130.

At step 406, the item image is compared to other images within the database and a list of comparable items is produced. The server 130 can perform the image recognition task or the mobile device 102 can receive images from the server 130 for comparison. For example, referring to FIG. 2, the image recognition unit 206 compares the item image to images of other items within the database 140. In one arrangement, the user can identify features in the image of particular importance. For example, the mobile device display 102 allows the user to point out particular sections of the image using a stylus or zoom feature. The user can isolate particular features of the item for applying weighted importance to increase the pattern recognition performance. Accordingly, the image recognition unit employs pattern recognition techniques known in the art for focusing in on the selected features and identifying items with similarly matching characteristics. An image is a substantial match when the pattern recognition unit 206 can accurately identify an item having all the features particularly pointed out by the user. The processor 204 provides a list of comparable items that substantially match the item image based on the results of the image recognition search.

At step 408, at least a portion of the list of comparable items can be published for auction. For example, referring to FIG. 2, the processor 204 presents descriptive information associated with the comparable items on the display 208, to the user, such as the price, age, and item location. Understandably, the list of comparable items are those items which substantially match the item of interest requested by the user. The user can select on item from the list to make a bid for purchase. The processor 204 receives input data from the user such as a bid price, a time to bid, an expiration time, and personal information to create a mobile bid. The processor publishes the mobile bid to the network thereby engaging in an auction for the comparable item of interest. The processor 204 establishes communication with at least one server 130 within the mobile communication environment. For example, the processor 204 can create a socket connection to a server using a universal datagram packet (UDP) or real time protocol (RTP), create a session initiated protocol (SIP) transaction, a packet data communication or the like. Notably, the processor 204 publishes the auction request by posting the mobile bid to an auction server, such as the server 130.

In one arrangement, item location data can be included with the search request to narrow the search. For example, a user may be interested in buying a standard commodity item that can be available at local outlet stores or local businesses. Accordingly, the buyer is interested in identifying business entities within a local geographic region. The buyer can enter a relative distance into the mobile device 102 specifying acceptable locations for purchase. The server 130 can present a list of comparables that satisfy the relative distance requirements of the buyer. Alternatively, the mobile device 102 can screen a list of comparable objects and present only those which satisfy the buyer distance criteria.

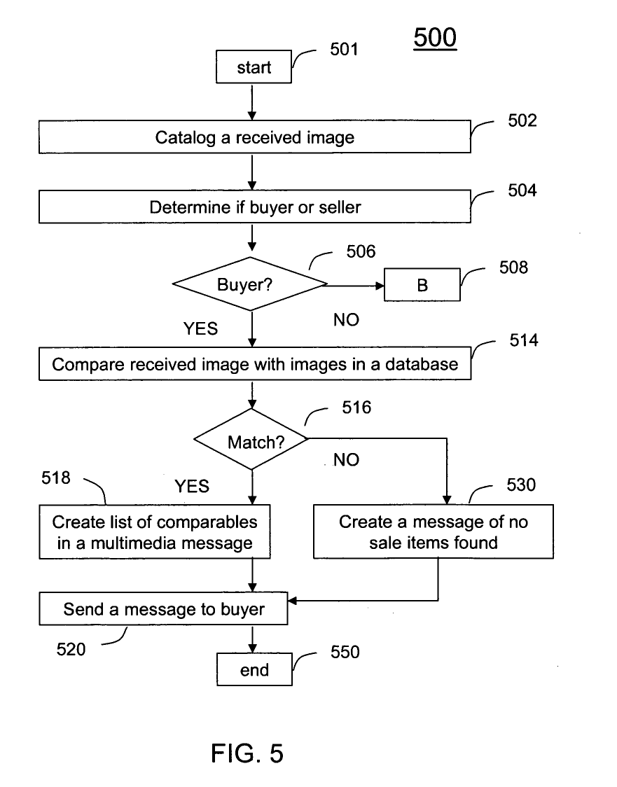

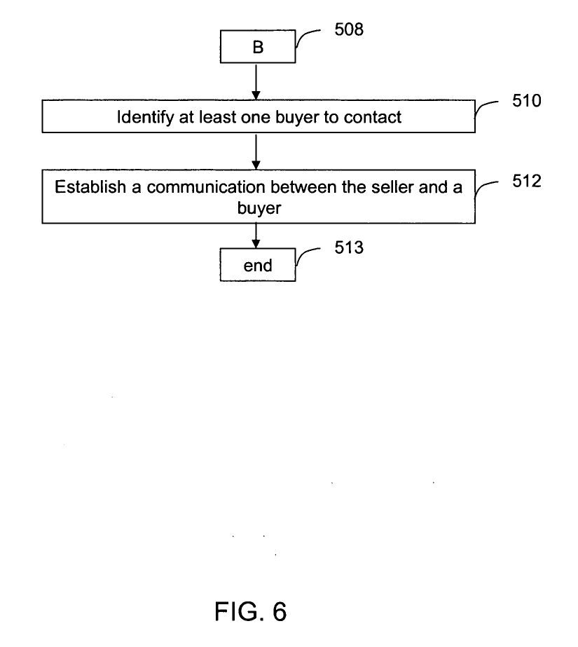

Referring to FIGS. 5 and 6, a flow chart of a method 500 for mobile auctioning at an auction server is shown. Notably, a mobile device communicates with the auction server for bidding on an item. Briefly, the mobile device publishes a mobile bid to participate in an auction. The mobile bid can be a request for a sale or a purchase of an item. The auction server responds to the bid by sending messages to the buyer thereby informing the buyer of potential items that match the item in the mobile bid and are available. The mobile device and auction server actively engage the buyer and the seller during the auction.

At step 501, the auction can start. At step 502, a received image can be catalogued. For example, referring to FIG. 2, a user of the mobile device 102 captures an image of an item of interest. The user enters descriptive information to associate with the item for sale or purchase. For example, a user may enter a price or a requested quality of the item. The processor 204 forms the association and catalogues the item image and description within the database. Alternatively, the processor 204 submits the item image and description to a server 130 for cataloguing.

At steps 504 and 506, a determination is made as to whether the user is a buyer or seller. Referring to FIG. 2, upon capturing an image of the item, the display 208 prompts the user to enter into a sell or a buy. For example, if the user is interested in purchasing the item, the user enters a buy option. If the user is interested in selling the item, the user enters a sell option. Accordingly, the processor 204 identifies whether the user is assuming the role of a buyer or seller from the user response. If the user is not a buyer the auction server considers the user a seller and proceeds to a selling transaction. Briefly, referring to FIG. 6, at step 510, at least one buyer to contact is identified. The mobile device 102 retrieves a buyer list containing buyers that have previously identified an interest in the item for sale, or for items of similar nature. For example, during an auction, the server 130 acquires buyer contact information to include in a buyer list during the cataloguing process. The server examines the buyer list for buyers potentially interested in or subscribing to items within the same category. Recall, the descriptive content associated with the message sent to the server includes personal information from the user. Accordingly, the mobile device receives a buyer list from the server 130 when the mobile device enters into a sell transaction. The display 208 presents the buyer list and the seller can enter into an auction with one of the buyers on the list.

In one aspect, the auction is a “live” real-time process where other participants can join. For example, a broker can sign up to receive live auction service. The auction server 130 sends auction messages to the broker informing the broker of items at auction that are available for sale or purchase. The broker can also search through buyer lists or seller lists to bring together buyers and sellers in the market. The broker can search through the items currently at auction within the image database 140. The broker can be a software application or a person. For example, a seller creates a software broker that searches for items of interest on behalf of the seller. For example, the seller may not be able to timely join an auction scheduled at a certain date. Understandably, the seller enters purchase information into a mobile bid and the broker participates in the auction using the mobile bid. The broker is a proxy for the seller to post bids on the item. In another aspect, a buyer searches a broker database looking for images that satisfy descriptive content for an item of interest.

At step 512, a communication between the buyer and seller can be established before completing the process at step 513. For example, referring back to FIG. 2, the auction server 130 and mobile device open up a line of communication upon a buyer, seller, or broker posting a bid on an item during auction. Lines of communication are opened to enter into a sale transaction, such as establishing a voice call or a direct connect dispatch. Understandably, a party may want to communicate with the other party before confirming the sale or purchase. The auction supports real-time voice and data connectivity for placing the two parties in direct contact. For example, the server 130 and mobile device 102 can communicate over a non-dedicated voice or data channel in a cellular communication network and switch to a dedicated voice channel. In another example, the mobile device 102 can setup a push-to-talk (PTX) call between the buyer and the seller. The PTX feature 214 provides immediate connectivity without requiring a party to dial a call. Implementations of the PTX feature are contemplated within the invention, which include a SIP connection, a streaming connection, or a packet based WLAN connection. In another arrangement, the mobile device 102 can flag a priority for a high quality of service (QoS) connection during a bid if PTX is unavailable.

Notably, steps 508-513 present auction steps for a seller, whereas steps 514-50 present auction steps for a buyer. Referring back to FIG. 5, at step 506, if the user is a buyer, the image received is compared to images in a database at step 514. For example, referring to FIG. 2, the pattern recognition unit 206 compares the image with other images in the database 140. At step 516, a determination as to whether a match is found is made. If a match is found, at step 518, a list or partial list of comparables is created in a message such as a multimedia message. For example, a user takes a picture of an item on the mobile device 102, and a portion of the list of comparable items is presented on the display of the mobile device. If a match is not found, a message of “no sale items found” can be created at step 530. At step 520, the message is sent to the user and optionally presented before the method is completed at step 550. For example, referring to FIG. 2, the processor 204 creates the message based on the results of a search for the item. Alternatively, referring to FIG. 3, the publisher 308 sends a multimedia message to the mobile device 102 informing the user that an item is available, or that an item is not available.

Where applicable, the present embodiments can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method of auctioning an item using a mobile device, comprising the steps of:
capturing an image of an item of interest;
entering said image into a database;
comparing said image to other images within said database for producing a list of comparable items; and
presenting at least a portion of said list of comparable items at the mobile device for auctioning.

2. The method of claim 1, further comprising the step of providing an auction concierge service for posting a sale or purchase of said item of interest.

3. The method of claim 1, further comprising including descriptive content with said image to identify at least one attribute of said item of interest.

4. The method of claim 3, wherein said attribute is one of a price, a quality, an age, a location, or a model of said item.

5. The method of claim 3, wherein said item of interest is an item of intended purchase within a predetermined distance of a user.

6. The method of claim 3, wherein said auction concierge service provides consumer reporting on uploaded images.

7. The method of claim 2, further comprising the step of conducting a live auction wherein a broker acquires at least one image at auction and searches for buyers on-line.

8. The method of claim 7, wherein said auction concierge service places a broker and a buyer in direct contact for bidding on said item of interest.

9. The method of claim 1, wherein a user takes a picture of said item of interest on a mobile communication device, and a portion of said list of comparable items are presented to said user on said mobile communication device wherein further the image of the comparable item substantially matches said image of said item.

10. The method of claim 1, further comprising the steps of:
identifying at least one party to contact; and
establishing communication between at least two parties for transacting a sale of said item.

11. The method of claim 1, further comprising the steps of:
determining a location of said mobile device; and
identifying an entity within a predetermined distance of said mobile device in view of said location,
wherein said entity has access to at least one comparable item that is available for purchase or sale.

12. The method of claim 3, wherein said auction concierge service provides an authentication process for ensuring secure transactions.

13. The method of claim 3, wherein said auction concierge service provides a monetary brokerage for closing finances of an auction transaction.

14. The method of claim 1, further comprising the steps of:
cataloging an image of an item of interest in a database;
identifying a party having interest in said item as a buyer or a seller; and
sending a message to said party for informing said party of comparable items within said database that are available for purchase or sale.

15. The method of claim 14, wherein a server hosts said database and matches a buyer's image with one or more seller's images for bringing together a buyer and a seller.

16. A mobile device for providing auction concierge services, comprising:
a camera for capturing an image of an item of interest;
a processor connected to said camera for entering said image into at least one database;
an image recognition unit communicatively coupled to said processor, wherein said image recognition unit compares said image to other images within a database for providing a list of comparable items to said processor; and
a display for presenting said list of comparable items available for sale or purchase.

17. The mobile device of claim 16, further comprising:
a push-to-talk feature for opening a direct line of communication; and
a positioning system communicatively coupled to said processor, wherein said positioning system determines a location of said mobile device; and said processor identifies a entity within a predetermined distance of said mobile device in view of said location.

18. The mobile device of claim 16, further comprising a timer, wherein said timer establishes a time limit for honoring a purchase or sale of said item.

19. The mobile device of claim 16, wherein at least one database is on a remote server.

20. A system for supporting auction concierge services comprising:
a processor for receiving and entering an image into at least one database;
an image recognition unit communicatively coupled to the processor; and
a publisher for publishing a list of comparable items available for auctioning.
